(19) United States
(12) Patent Application Publication
(10) Pub. No.: US 2017/0242797 A1
(43) Pub. Date: Aug. 24, 2017

(54) REDUCING INTERCONNECT TRAFFICS OF MULTI-PROCESSOR SYSTEM WITH EXTENDED MESI PROTOCOL

(71) Applicant: INTEL CORPORATION, Santa Clara, CA (US)

(72) Inventors: Kebing WANG, Shanghai (CN); Bianny BIAN, Shanghai (CN)

(21) Appl. No.: 15/505,883

(22) PCT Filed: Sep. 25, 2014
(86) PCT No.: PCT/CN2014/087409

§ 371 Date: Feb. 22, 2017

(51) Int. Cl. G06F 12/0808; G06F 12/0831; G06F 12/0811

(52) U.S. Cl. CPC G06F 12/0808; G06F 12/0811; G06F 12/0831; G06F 2212/283; G06F 2212/621

(57) ABSTRACT

A processor includes a first core including a first cache including a cache line, a second core including a second cache, and a cache controller to set a flag stored in a flag section of the cache line of the first cache to one of a processor share (PS) state in response to data stored in the cache line being shared by the second cache, or to a global share (GS) state in response to the data stored in the first cache line being shared by a third cache of a second processor.

### TECHNICAL FIELD

The embodiments of the disclosure relate generally to managing caches of one or more processors and, more specifically, relate to reducing traffic on the interconnect fabric system of a multi-processor system using an extended MESI protocol.

### BACKGROUND

A processor may include one or more processing cores, caches, and a cache controller used to manage read and write operations directed to a main memory. The cache controller is a circuit logic coupled to a processing core and main memory to manage the operations on the caches. Caches may include different types of caches. For example, a processing core may include an L1 cache that is dedicated to the processing core. A processor of multiple cores may include an L2 cache that is shared by several cores. Further, all cores of a processor may share a common L3 cache. In certain implementations, an on-chip last level cache (LLC) may be shared by multiple processors on a system-on-a-chip (SoC). Each cache may include one or more cache lines to store local copies of data stored in the main memory and the addresses of the data stored in the main memory. The cache controller of the processor may manage L1-L3 caches according to a cache coherence protocol to ensure the consistency of shared data whose copies are stored in multiple caches.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a processing device including processing cores according to an embodiment of the present disclosure.

FIG. 2 illustrates a cache line of a cache according to an embodiment of the present disclosure.

FIG. 3 is a state diagram of an extended MESI protocol according to an embodiment of the present disclosure.

FIG. 4A is a block diagram of a method to assign a flag of a cache line to one of shared states according to an embodiment of the present disclosure.

FIG. 4B is a block diagram of a method to broadcast a cache invalidation request based on the flag stored in a cache line according to an embodiment of the present disclosure.

FIG. 5A is a block diagram illustrating a micro-architecture for a processor including heterogeneous core in which one embodiment of the disclosure may be used.

FIG. 5B is a block diagram illustrating an in-order pipeline and a register renaming stage, out-of-order issue/execution pipeline implemented according to at least one embodiment of the disclosure.

FIG. 6 illustrates a block diagram of the micro-architecture for a processor that includes logic in accordance with one embodiment of the disclosure.

FIG. 7 is a block diagram illustrating a system in which an embodiment of the disclosure may be used.

FIG. 8 is a block diagram of a system in which an embodiment of the disclosure may operate.

FIG. 9 is a block diagram of a system in which an embodiment of the disclosure may operate.

FIG. 10 is a block diagram of a System-on-a-Chip (SoC) in accordance with an embodiment of the present disclosure.

FIG. 11 is a block diagram of an embodiment of an SoC design in accordance with the present disclosure.

FIG. 12 illustrates a block diagram of one embodiment of a computer system.

### DETAILED DESCRIPTION

The MESI protocol is a type of cache coherence protocol. Under the MESI protocol, the cache controller may mark a cache line with one of “Modified,” “Exclusive,” “Shared,” or “Invalid” state. The Modified (M) state indicates that the cache controller determines that the copy stored in the cache line has been modified from the data stored in the main memory. The cache is required to write the data back to main memory at some time in the future before permitting any other read of the (no longer valid) main memory state. The write-back from the cache to the main memory causes the cache controller to change the state of the cache line to the Exclusive (E) state. The Exclusive (E) state indicates that the cache controller determines that the cache line matches the data stored in the main memory and is not shared by other caches. The cache controller may change the state of the cache line to the Shared state in response to a read request to the main memory originated from another processing core or another processor. Alternatively, the cache controller may change the state of the cache line to the Modified state when the content of the cache line is written over. The Shared (S) state indicates that the cache controller determines that the cache line is also stored in another cache (e.g., after being read by another processing core or another processor). The Invalid (I) state indicates that the cache controller determines that the cache line is invalid (or unused).

More and more cores have been integrated into a processor with the development of semiconductor technology. With multiple cores, a processing device may include multiple processors, each processor may include multiple core clusters of processing cores, and each cluster may include multiple processing cores. However, the MESI protocol treats a processor having a single processing core and multiple processors having multiple core clusters and multiple processing cores equally. For example, the Shared (S) state of the MESI protocol indicates that the data copies are distributed on different processors. In the event of a write to the main memory location corresponding to the cache line, the cache controller needs to broadcast a cache invalidation request message to all processors and their cores to request changing the state of the copies of the cache line in other caches from the Shared (S) state to the Invalid (I) state. The cache invalidation request may be transmitted over an interconnect fabric system to which the multiple processors are coupled. When the numbers of processors and the processing cores therein are high, the broadcast of the invalidation requests may cause heavy traffic on the interconnection fabric system.

Embodiments of the present disclosure may include a processing device including one or more processors, each processor including one or more processing cores and caches that are managed by one or more cache controllers using a cache coherence protocol whose states take into consideration different levels of grouping of processing cores.

In one embodiment, the protocol may support different types of shared states according to which core shares the data. In one embodiment, the shared states of the extended MESI may include three shared states of a Cluster Share (CS), a Processor Share (PS), and a Global Share (GS) state, rather than a single Shared (S) state of the MESI protocol. The Cluster Share (CS) state of a cache line indicates that the data stored in the cache line may have copies stored in caches of different processing cores comprised by a core cluster that the processing core belongs to, but do not have copies in any cache outside the core cluster. In one embodiment, core clusters of processing cores are specified by the manufacturer of the processor. The Processor Share (PS) state of a cache line indicates that copies of the data stored in the cache line may have copies stored in caches in processing cores of more than one cluster in the processor, but do not have copies outside the processor. The Global Share (GS) state indicates that the data stored in the cache line may have copies globally in caches in all processors and processing cores within a processing device.

Under the extended MESI protocol, a cache controller may broadcast a cache message (such as a cache invalidation request) to a targeted group of processing cores based on whether the cache line is in the Cluster Share (CS), Processor Share (PS), or Global Share (GS) state, thereby reducing the traffic caused by always globally broadcasting cache messages on the interconnect fabric system.

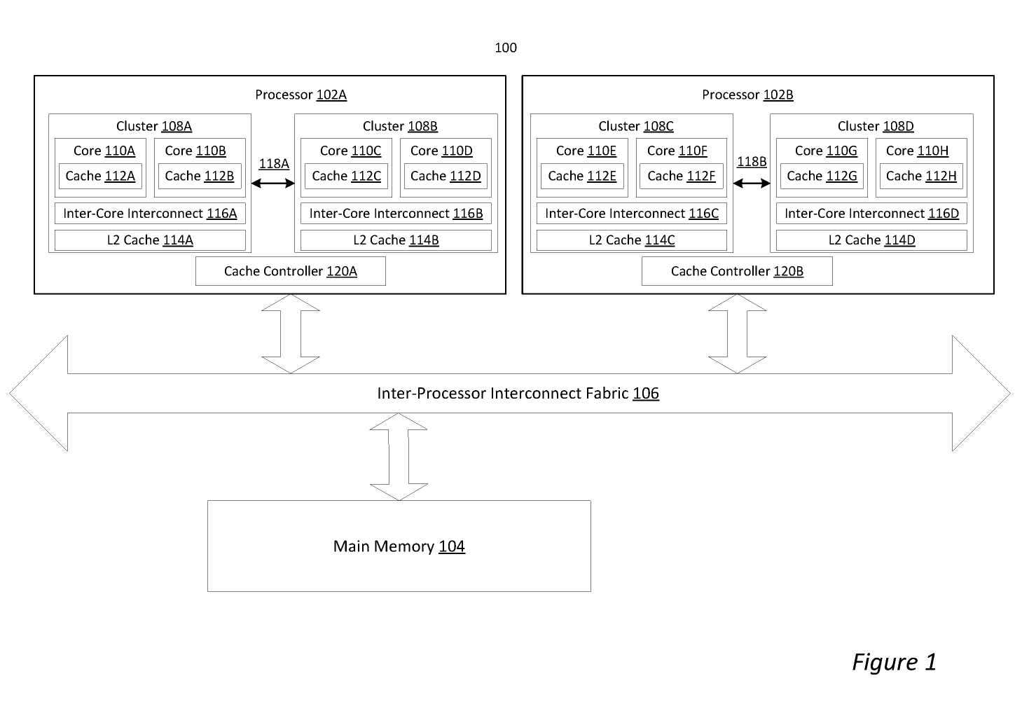

FIG. 1 illustrates a system-on-a-chip (SoC) 100 including processing cores according to an embodiment of the present disclosure. The SoC 100 may include one or more processors 102A-102B, and a main memory 104. Each processor 102A, 102B may further include one or more processing cores. As shown in FIG. 1, the processor 102A may include processing cores 110A-110D, and the processor 102B may include processing cores 110E-110H. Each processing core 110A-110H may include a respective L1 cache 112A-112H dedicated to the corresponding processing core. In one embodiment, the processing cores may be grouped into core clusters by the manufacturer of the processors 102A, 102B (or by a user of the SoC 100). A core cluster may include a group of clusters that are geographically proximate to each other. In one embodiment, the core cluster may be a design unit of a processor that enjoys dedicated resources shared by cores in the core cluster. For example, cores of a core cluster may share a dedicated L2 cache. As shown in FIG. 1, in the processor 102A, processing cores 110A, 110B may form the core cluster 108A, and processing cores 110C, 110D may form the core cluster 108B. Similarly, processing cores 110E-100H may form core clusters 108C, 108D, respectively, in the processor 102B.

In one embodiment, multiple processing cores may share an L2 cache. For example, as shown in FIG. 1, processing cores in clusters 108A-108D may respectively share L2 cache 114A-114D. Additionally, the processors 102A, 102B may share L3 caches (not shown).

The processing cores 110A-110D, core clusters 108A-108D, and processors 102A-102B as well as different levels of caches 112A-112H, 114A-114D may be interconnected within the SoC 100 by an interconnect fabric system. The interconnect fabric system may transmit instructions and data among processing cores, core clusters, and processors.

In one embodiment, the interconnect fabric system may include different types of interconnects to connect among cores, core clusters, and processors. In one embodiment, as shown in FIG. 1, the processing cores 110A-110B of core cluster 108A may be connected by the inter-core interconnect 116A; the processing cores 110C 110D of the core cluster 108B may be connected by the inter-core interconnect 116B; the processing cores 110E-110F of the core cluster 108C by the inter-core interconnect 116C; and the processing cores 110G-110H of the core cluster 108D by the inter-core interconnect 116D. Inter-core communication, including data communication and instruction/control messages among processing cores within a processing cluster, may be transmitted via the inter-core interconnects 116A-116D.

The core clusters on a processor may be connected with inter-cluster interconnect fabric. In one embodiment, as shown in FIG. 1, the core cluster 108A and the core cluster 108B of the processor 102A may be connected with the inter-cluster interconnect 118A, and the core cluster 108C and the core cluster 108D may be connected with the inter-cluster interconnect 118B. Thus, communications including data communication and instruction/control messages between a first processing core in a first core cluster and a second processing core in a second core cluster on the same processor may be transmitted via the inter-cluster interconnects 118A, 118B. For example, the processing core 110A may communicate with the processing core 110C via the inter-cluster interconnect 118A. Both the inter-core interconnects 116A-116D and the inter-cluster interconnects 118A-118B are on-chip interconnect fabrics. However, the inter-core interconnects 116A-116D are interconnects on a cluster module. In contrast, the inter-cluster interconnects 118A-118B are between cluster modules (or off the cluster module).

The inter-processor interconnect fabric 106 may connect the processors 102A, 102B and the main memory 104 for the communication between processing cores 110A-110H and the main memory 104 and for the communication between two processing cores that reside on two separate processors. For example, the processing core 110A may read data from or write data to the main memory via the inter-processor interconnect 106. Also, the processing core 110A of the processor 102A may communicate with the processing core 110E of the processor 102B via the inter-processor interconnect 106. In one embodiment, the inter-processor interconnect 106 may be an off-chip interconnect.

In one embodiment, each processor 102A, 102B may further include a respective cache controller 116A, 116B coupled to processing cores 110A-110H and the main memory 104. The cache controllers 116A, 116B are circuit logics that control the interface between the processing cores 110A-110H, caches 112A-112H, 114A-114D, and the main memory 104. In one implementation, the cache controllers 120A, 120B may monitor the interconnect fabric system for any write and/or read operations occurred to the main memory 104 or any status changes of cache lines in caches in the SoC 100 on behalf of the caches on the processor. As shown in FIG. 1, the cache controller 120A may monitor the interconnect fabric system (including the inter-core interconnects 116A-116D, the inter-core interconnects 118A-118B, and the inter-processor interconnect 106) for caches 112A-112D and the cache 114A-114B, and the cache controller 120B may monitor the interconnect fabric system for the caches 112E-112H and the caches 114C-114D.

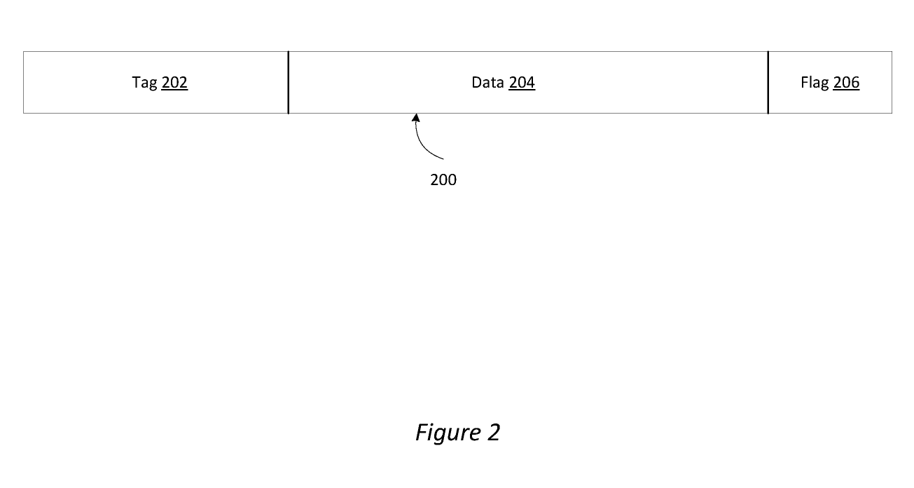

Different levels of caches (e.g., L1-L3) are utilized to stored local copies of data stored in the main memory 104 to reduce the access time to data stored in the main memory. Each cache may include one or more cache lines for storing a piece of data stored in the main memory. FIG. 2 illustrates an exemplary cache line 200 including a tag portion 202, a data portion 204, and flag portion 206. Each cache in the SoC 100 may include multiple cache lines as the exemplary cache line 200. The data section 204 may store a copy of the corresponding data stored in the main memory. The tag section 202 may store the address of the main memory at which the data 204 is stored. The flag 206 section may store a state indicator of the cache line according to a certain cache coherence protocol to ensure that the access to the cache line 200 and the corresponding data in the main memory is consistent and correct.

To reduce the access time, when a processing core needs to read from an address of the main memory, the processing core may first check the caches in the processor including the processing core or the caches of another processor to determine if there is a copy in the caches. If there is a copy stored in one or more caches, the processing core reads the copy in the one or more caches rather than from the main memory 104 because the retrieval from the main memory is often slower. When the processing core needs to write data to an address at the main memory, the processing core may need to check if there are one or more copies of the data stored in cache lines of caches. If there are copies stored in the one or more cache lines, the processing core may need to cause the cache controller to change the state of the one or more cache lines (e.g., changing to an invalid state) and/or update the data stored in the cache lines.

Since data stored in the main memory 104 may have multiple copies stored at different cache lines of different caches in one or more processors, the data consistency among caches and the main memory 104 needs to be maintained according to a cache coherence protocol. This may be achieved through the snooping on the interconnect system fabric by one or more cache controller. Snooping is a process that a cache controller monitors the address lines of the main memory for access (read or write) to the memory location that a cache has a local copy. As shown in FIG. 1, the cache controllers 120A, 120B may monitor activities at the address line of the main memory 104 to detect if there are any read or write operations on behalf of caches 110A-110H, 114A-114D and set the state of the corresponding cache lines in accordance to the cache coherence protocol.

A cache coherence protocol is the MESI protocol including “Modified,” “Exclusive,” “Shared,” and “Invalid” states that may be used to mark a cache line. Under the MESI protocol, the Shared (S) state of a cache line indicates that the data stored in the cache line is shared by another cache (or has a copy in another cache), but does not tell whether the sharing caches are from the same core cluster, or from the same processor, or from other processors. For example, if a cache line in the cache 112A has a Shared (S) state because a copy of the data stored in the cache line is also stored in the cache 112B, when processing core 110A writes to a location of the main memory corresponding to the cache line stored in cache 112A, a snoop including a cache invalidation request needs to be sent to all caches (and their cache controllers) on the SoC 100 to inform all caches to invalidate their copies if they have one. This is because the processing core 110A does not know which cache is the sharing cache, and therefore, the processing core 110A has to inform all caches via the inter-processor interconnect 106, although, in reality, the processing core 110A only needs to inform caches 112B via the inter-core interconnect 116A. As such, unnecessary traffic is generated on the inter-processor interconnect 106 due to the non-discriminating? Shared (S) state.

Embodiments of the present disclosure may include a processor including a cache controller to manage the caches of the processor according an extended MESI protocol. The extended MESI protocol may divide the Shared state into two or more specific shared states to identify how the data stored in a cache line is shared. In one embodiment, the extended MESI protocol may include a state of “Cluster Share” (CS) of a cache line indicating that the data stored in the cache line is shared by another cache within the same core cluster, but not outside the core cluster. For example, if data stored in a cache line in cache 112A is marked with a CS state, the data stored in the cache line may be shared by caches 112B, 114A within the core cluster 108A, but not outside the core cluster 108A.

In one embodiment, the extended MESI protocol may further include a state of “Processor Share” (PS) of a cache line indicating that the data stored in the cache line may be shared by another cache in another core cluster within the same processor, but not outside the processor. For example, if data stored in a cache line in cache 112A is marked with a PS state, the data stored in the cache line may be shared in caches 112C, 112D, 116B, 112B, or 114A, but not outside processor 102A.

In one embodiment, the extended MESI protocol may further include a state of “Global Share” (GS) of a cache line indicating that the data stored in the cache line could be shared by any cache in the SoC 100 including caches in another processor. For example, if data stored in a cache line of cache 112A is marked with the GS state, the data may be shared by a cache line in any of the caches.

In addition to the CS, PS, and GS states, in one embodiment, the extended MESI protocol may also include the “Modified” (M), “Exclusive” (E), and “Invalid” (I) states. Similar to the MESI protocol, the M state indicates the data stored in the cache line has been modified from the copy stored in the main memory 104 and therefore, needs to write back to the main memory at a future time. The E state indicates that the data stored in the cache line is not shared by other caches and is consistent with the main memory 104. The I state indicates that the data stored in the cache line is invalid because the corresponding data stored in the main memory has been written over.

Because the classification of the shared states into Cluster Share, Processor Share, and Global Share, the cache controllers 120A, 120B may send certain cache management requests (e.g., cache invalidation requests) to selected interconnects based on the shared states instead of always broadcasting globally. This may reduce the snoop traffic on the interconnect fabric system. In one embodiment, if the cache line marked with a CS state, in response to receiving an instruction to write over the data stored in the main memory 104 at an address corresponding to the cache line, the cache controller may broadcast a cache invalidation request to caches within the core cluster via inter-core interconnects. For example, if a cache line in cache 112A is marked with CS state and the cache controller 120A detects a write operation by the core 110A in the main memory 104 at a location corresponding to the cache line, the cache controller 120 may send a cache invalidation request via inter-core interconnect 114A to caches 112B, 114A. In this way, the snoop traffic is limited within the cluster 108A.

In one embodiment, if the cache line in the cache 112A is marked with a PS state and the cache controller 120A detects a write operation by the core 110A in the main memory 104 at a location corresponding to the address stored in the cache line, the cache controller 120 may send a cache invalidation request via inter-cluster interconnect 118A to caches 112B-112D, 114A-114B within the processor 102A. In this way, the snoop traffic is limited within the processor 102A.

A cache hit may cause a cache line to change its state to one of the extended MESI states. A cache hit is a read probe from another cache at the location in the main memory corresponding to the cache line. Before providing the data to the requester, the cache controller may set the state of the cache line to one of CS, PS, or GS state depending on the present state of the cache line and the location of the requester of the cache hit. The identity of the requester may be part of the read probe.

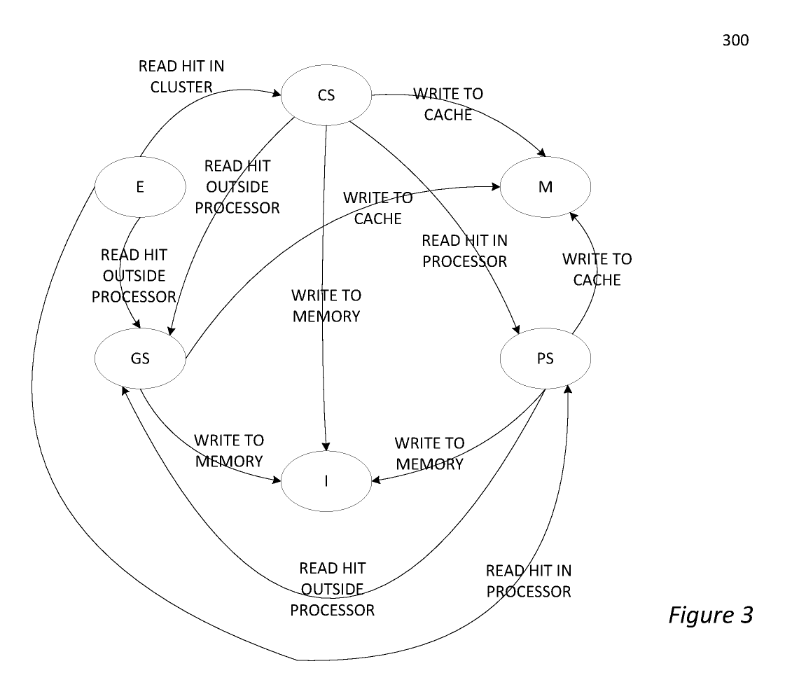

FIG. 3 is a state diagram that illustrates the transitions among different states of the extended MESI protocol. In one embodiment, if the present state of the cache line is “Exclusive” (E), the cache controller may change the state to “Cluster Share” (CS) in response to the cache controller detecting a cache hit and identifying that another cache within the same core cluster is the originator of the cache hit, or change the state to “Processor Share” (PS) in response to the cache controller detecting a cache hit and identifying that another cache outside the core cluster but within the same processor is the originator of the cache hit, or change the state to “Global Share” (GS) in response to the cache controller detecting a cache hit and identifying that a cache in another processor is the originator of the cache hit.

In one embodiment, if the present state of the cache line is CS, the cache controller may change the state to PS in response to detecting a cache hit from another cache outside the core cluster but within the same processor, or change to the state to GS in response to a cache hit from another processor.

In one embodiment, if the present state of the cache line is PS, the cache controller may change the state to GS in response to a cache hit from another processor. However, a cache hit from another cache within the same cache cluster does not change the state of the cache line.

In one embodiment, if a cache line is in one of the CS, PS, or GS states, in response to detecting a write hit in the cache (i.e., write to a cache whose content has not been sent to the memory), the cache controller may first broadcast a cache invalidation request for all caches in the cluster, in the processor, or globally to request an invalidation of copies of the data stored in the cache line. Thereafter, the cache controller may allow the processing core to write in the cache line, and change the flag of the cache line to “Modified” (M). Since the broadcast of the cache invalidation request is selectively targeted towards caches in the cache cluster, processor, or globally, the snoop traffic on the interconnect fabric system may be reduced.

In one embodiment, if a cache line is in one of the CS, PS, or GS states in response to detecting an cache invalidation request to invalidate the copy stored in the cache line, the cache controller may change the flag of the cache line from the CS, PS, or GS to “Invalid” (I).

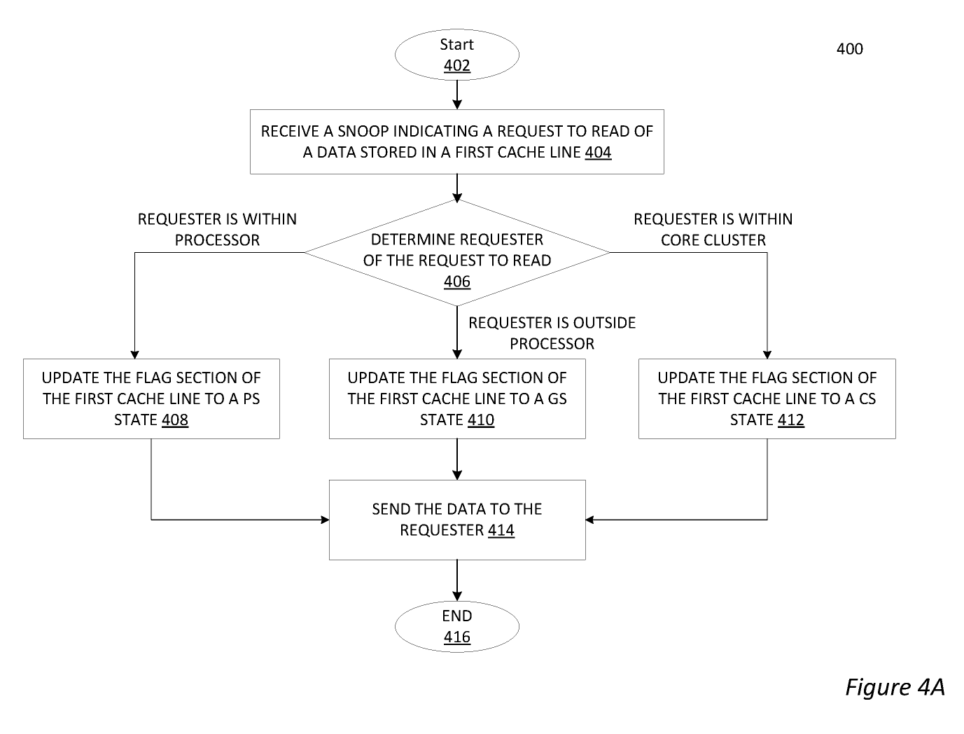

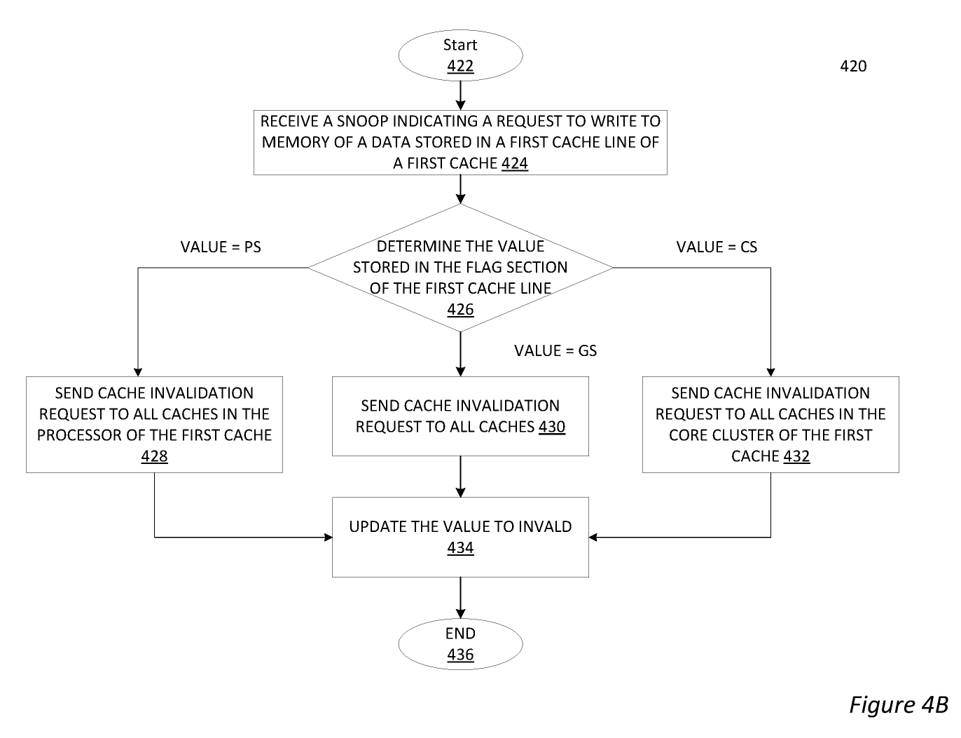

FIG. 4A is a block diagram of a method to assign a flag of a cache line to one of shared states according to an embodiment of the present disclosure. Method 400 may be performed by processing logic that may include hardware (e.g., circuitry, dedicated logic, programmable logic, microcode, etc.), software (such as instructions run on a SoC, a general purpose computer system, or a dedicated machine), firmware, or a combination thereof. In one embodiment, method 400 may be performed, in part, by processing logics of the cache controllers 120A-120B as shown in FIG. 1.

For simplicity of explanation, the method 400 is depicted and described as a series of acts. However, acts in accordance with this disclosure can occur in various orders and/or concurrently and with other acts not presented and described herein. Furthermore, not all illustrated acts may be performed to implement the method 400 in accordance with the disclosed subject matter. In addition, those skilled in the art will understand and appreciate that the method 400 could alternatively be represented as a series of interrelated states via a state diagram or events.

Referring to FIG. 4A, at 402, the operations start. At 404, the cache controller of a processor may monitor the interconnect fabric system of a processing device for a request to read data stored in a cache line of a core in the processor. If the cache line contains the requested data, the cache controller detects a cache hit and may need to provide the data to the requester to avoid retrieving data from the memory. The request may be generated in response to an attempt to read the main memory by a second core of the processor or of another processor. Instead of retrieving the data from the main memory, the second core (via another cache controller or the same cache controller) may first send a read probe to the caches in the SoC to search for a copy of the data stored in the local caches.

In response to detecting the request, at 406, the cache controller may determine where the request to read comes from. In one embodiment, the cache controller may determine the identity of the requester of the request based on the snoop (or the read probe) received from the interconnect fabric system. The snoop may include an identification of the requesting processor and identification of the requesting core inside the requesting processor.

In response to a determination that the request to read comes from a requesting core that is within the same core cluster of the receiving cache, at 412, the cache controller may set the flag stored in the flag section of the cache line from “Exclusive” to “Cluster Share.” In response to a determination that the request to read comes from a core in another core cluster within the same processor, at 410, the cache controller may set the flag stored in the flag section of the cache line from “Exclusive” or “Cluster Share” to “Processor Share.” In response to a determination that the request to read comes from a core in another processor, at 408, the cache controller may set the flag stored in the flag section of the cache line from “Exclusive,” “Cluster Share,” or “Processor Share” to “Global Share.”

After setting the flag section of the cache line to one of “Cluster Share,” “Processor Share,” or “Global Share,” at 414, the cache controller may transmit the data stored in the cache line to the requester to store in a cache of the requester. The cache controller may transmit the data on the inter-core interconnect for “Cluster Share,” on the inter-cluster interconnect for “Processor Share,” and on the inter-processor interconnect for “Global Share.”

FIG. 4B is a block diagram of a method to broadcast a cache invalidation request based on the flag stored in a cache line according to an embodiment of the present disclosure. Method 420 may be performed by processing logic that may include hardware (e.g., circuitry, dedicated logic, programmable logic, microcode, etc.), software (such as instructions run on a processing device, a general purpose computer system, or a dedicated machine), firmware, or a combination thereof. In one embodiment, method 400 may be performed, in part, by processing logics of the cache controllers 120A-120B as shown in FIG. 1.

For simplicity of explanation, the method 400 is depicted and described as a series of acts. However, acts in accordance with this disclosure can occur in various orders and/or concurrently and with other acts not presented and described herein. Furthermore, not all illustrated acts may be performed to implement the method 400 in accordance with the disclosed subject matter. In addition, those skilled in the art will understand and appreciate that the method 420 could alternatively be represented as a series of interrelated states via a state diagram or events.

Referring to FIG. 4B, at 422, the operations start. At 424, the cache controller of a cache of a core inside a processor may receive a request to write over the copy of data stored in the cache line. The write operation may create a discrepancy between the data stored in the cache line and the main memory. At 426, the cache controller may determine the flag stored in the flag section of the cache line. If the flag indicates “Exclusive,” or “Modified,” the data stored in the cache line does not have copies stored in other caches. However, if the flag indicates one of the shared states, the cache controller may need to send out a cache invalidation request to those sharing caches based on the flag of the flag section.

In response to a determination that the flag of the flag section is “Cluster Share,” at 432, the cache controller may send the cache invalidation request to all caches within the core cluster on the inter-core interconnect. In response to a determination that the flag of the flag section is “Processor Share,” at 428, the cache controller may send the cache invalidation request to all caches within the processor on the inter-cluster interconnect. In response to a determination that the flag of the flag section is “Global Share,” at 430, the cache controller may send the cache invalidation request to all caches of the SoC in which the cache resides. In this way, the cache invalidation request is targeted to a specific domain according to the share states, thus reducing snoop traffic. After sending the cache invalidation request, at 434, the cache controller may set the flag of the flag section of the cache line to “Modified.”

In one embodiment, the cache coherence protocol may include additional states other than the “Modified,” “Exclusive,” “Cluster Share,” “Processor Share,” “Global Share,” and “Invalid” states. According to one embodiment of the present disclosure, a cache coherence protocol may include an additional “Forward” (F) state indicating that the one cache line flagged with the “Forward” state is responsible for forwarding the data to the requester of the data. In this way, the requester receives only one copy from the one cache line flagged with “Forward” rather than receiving multiple copies of the same data from different cache lines holding the data. In one embodiment, the “Forward” state may be split into “Cluster Forward” (CF), “Processor Forward” (PF), or “Global Forward” (GF) so that the cache controller may determine whether to forward the data based on whether the requester is within the core cluster, within the processor, or from another processor. In this way, the cache controller may utilize the most efficient cache to forward the data.

According to another embodiment of the present disclosure, a cache coherence protocol may include an additional “Owned” state indicating that the cache is one of several caches with the copy of the cache line, but has the exclusive right to make a change of the cache line. The cache with the “Owned” state may need to broadcast the change to all other caches sharing the cache line. In one embodiment, the “Owned” state may also be split into “Cluster Owned” (CO), “Processor Owned” (PO), or “Global Owned” (GO) so that the cache controller broadcasts a change to the cache line in the core cluster, in the processor, or globally, according to whether the cache line is in “Cluster Owned,” “Processor Owned,” or “Global Owned.”

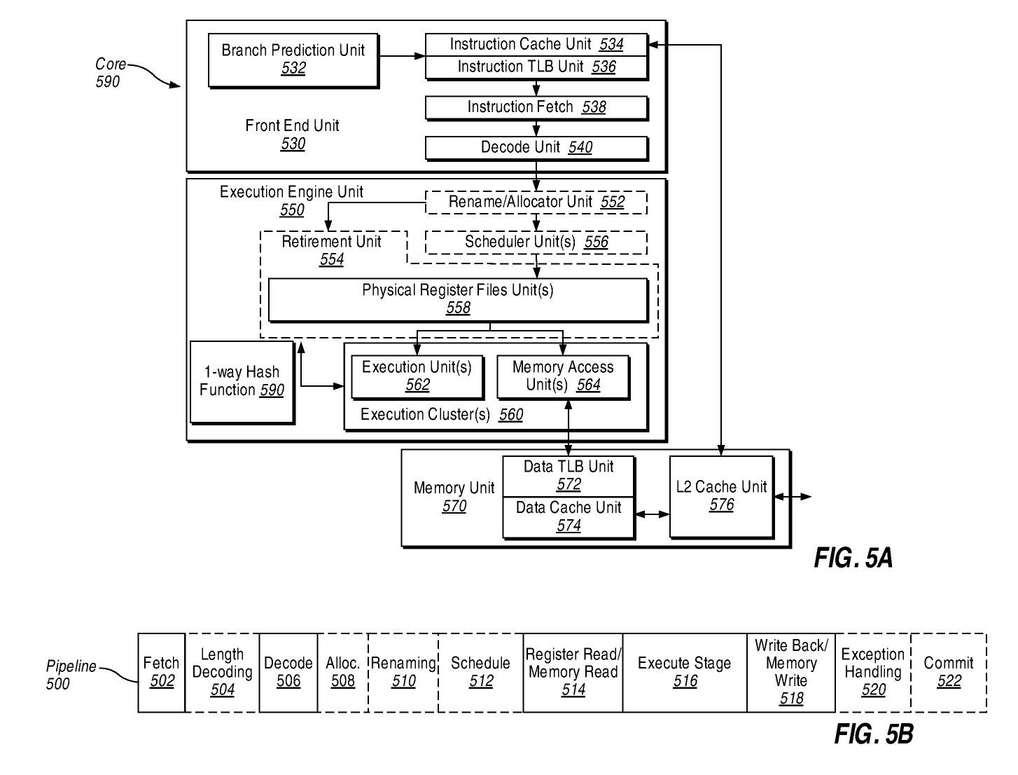

FIG. 5A is a block diagram illustrating a micro-architecture for a processor 500 that implements the processing device including heterogeneous cores in accordance with one embodiment of the disclosure. Specifically, processor 500 depicts an in-order architecture core and a register renaming logic, out-of-order issue/execution logic to be included in a processor according to at least one embodiment of the disclosure.

Processor 500 includes a front end unit 530 coupled to an execution engine unit 550, and both are coupled to a memory unit 570. The processor 500 may include a reduced instruction set computing (RISC) core, a complex instruction set computing (CISC) core, a very long instruction word (VLIW) core, or a hybrid or alternative core type. As yet another option, processor 500 may include a special-purpose core, such as, for example, a network or communication core, compression engine, graphics core, or the like. In one embodiment, processor 500 may be a multi-core processor or may part of a multi-processor system.

The front end unit 530 includes a branch prediction unit 532 coupled to an instruction cache unit 534, which is coupled to an instruction translation look aside buffer (TLB) 536, which is coupled to an instruction fetch unit 538, which is coupled to a decode unit 540. The decode unit 540 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 540 may be implemented using various different mechanisms. Examples of suitable mechanisms include, but are not limited to, look-up tables, hardware implementations, programmable logic arrays (PLAs), microcode read only memories (ROMs), etc. The instruction cache unit 534 is further coupled to the memory unit 570. The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations (RS), central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 558 is overlapped by the retirement unit 554 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

In one implementation, processor 500 may be the same as processor 202 described with respect to FIG. 2.

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline each having their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which may include a data prefetcher 580, a data TLB unit 572, a data cache unit (DCU) 574, and a level 2 (L2) cache unit 576, to name a few examples. In some embodiments DCU 574 is also known as a first level data cache (L1 cache). The DCU 574 may handle multiple outstanding cache misses and continue to service incoming stores and loads. It also supports maintaining cache coherency. The data TLB unit 572 is a cache used to improve virtual address translation speed by mapping virtual and physical address spaces. In one exemplary embodiment, the memory access units 564 may include a load unit, a store address unit, and a store data unit, each of which is coupled to the data TLB unit 572 in the memory unit 570. The L2 cache unit 576 may be coupled to one or more other levels of cache and eventually to a main memory.

In one embodiment, the data prefetcher 580 speculatively loads/prefetches data to the DCU 574 by automatically predicting which data a program is about to consume. Prefeteching may refer to transferring data stored in one memory location of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 500 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 5B is a block diagram illustrating an in-order pipeline and a register renaming stage, out-of-order issue/execution pipeline implemented by processing device 500 of FIG. 5A according to some embodiments of the disclosure. The solid lined boxes in FIG. 5B illustrate an in-order pipeline, while the dashed lined boxes illustrates a register renaming, out-of-order issue/execution pipeline. In FIG. 5B, a processor pipeline 500 includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524. In some embodiments, the ordering of stages 502-524 may be different than illustrated and are not limited to the specific ordering shown in FIG. 5B.

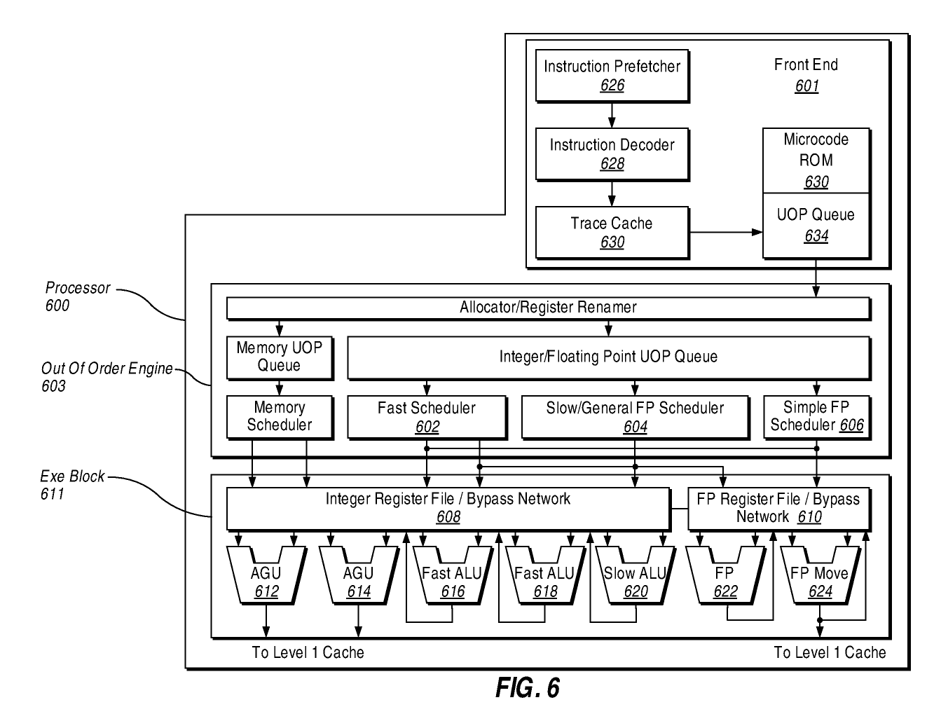

FIG. 6 illustrates a block diagram of the micro-architecture for a processor 600 that includes hybrid cores in accordance with one embodiment of the disclosure. In some embodiments, an instruction in accordance with one embodiment can be implemented to operate on data elements having sizes of byte, word, doubleword, quadword, etc., as well as data types, such as single and double precision integer and floating point data types. In one embodiment the in-order front end 601 is the part of the processor 600 that fetches instructions to be executed and prepares them to be used later in the processor pipeline.

The front end 601 may include several units. In one embodiment, the instruction prefetcher 626 fetches instructions from memory and feeds them to an instruction decoder 628 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 630 takes decoded uops and assembles them into program ordered sequences or traces in the uop queue 634 for execution. When the trace cache 630 encounters a complex instruction, the microcode ROM 632 provides the uops needed to complete the operation.

Some instructions are converted into a single micro-op, whereas others need several micro-ops to complete the full operation. In one embodiment, if more than four micro-ops are needed to complete an instruction, the decoder 628 accesses the microcode ROM 632 to do the instruction. For one embodiment, an instruction can be decoded into a small number of micro ops for processing at the instruction decoder 628. In another embodiment, an instruction can be stored within the microcode ROM 632 should a number of micro-ops be needed to accomplish the operation. The trace cache 630 refers to an entry point programmable logic array (PLA) to determine a correct micro-instruction pointer for reading the micro-code sequences to complete one or more instructions in accordance with one embodiment from the micro-code ROM 632. After the microcode ROM 632 finishes sequencing micro-ops for an instruction, the front end 601 of the machine resumes fetching micro-ops from the trace cache 630.

The out-of-order execution engine 603 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 602, slow/general floating point scheduler 604, and simple floating point scheduler 606. The uop schedulers 602, 604, 606, determine when a uop is ready to execute based on the readiness of their dependent input register operand sources and the availability of the execution resources the uops need to complete their operation. The fast scheduler 602 of one embodiment can schedule on each half of the main clock cycle while the other schedulers can only schedule once per main processor clock cycle. The schedulers arbitrate for the dispatch ports to schedule uops for execution.

Register files 608, 610, sit between the schedulers 602, 604, 606, and the execution units 612, 614, 616, 618, 620, 622, 624 in the execution block 611. There is a separate register file 608, 610, for integer and floating point operations, respectively. Each register file 608, 610, of one embodiment also includes a bypass network that can bypass or forward just completed results that have not yet been written into the register file to new dependent uops. The integer register file 608 and the floating point register file 610 are also capable of communicating data with the other. For one embodiment, the integer register file 608 is split into two separate register files, one register file for the low order 32 bits of data and a second register file for the high order 32 bits of data. The floating point register file 610 of one embodiment has 128 bit wide entries because floating point instructions typically have operands from 64 to 128 bits in width.

The execution block 611 contains the execution units 612, 614, 616, 618, 620, 622, 624, where the instructions are actually executed. This section includes the register files 608, 610, that store the integer and floating point data operand values that the micro-instructions need to execute. The processor 600 of one embodiment is comprised of a number of execution units: address generation unit (AGU) 612, AGU 614, fast ALU 616, fast ALU 618, slow ALU 620, floating point ALU 622, floating point move unit 624. For one embodiment, the floating point execution blocks 622, 624, execute floating point, MMX, SIMD, and SSE, or other operations. The floating point ALU 622 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 616, 618. The fast ALUs 616, 618, of one embodiment can execute fast operations with an effective latency of half a clock cycle. For one embodiment, most complex integer operations go to the slow ALU 620 as the slow ALU 620 includes integer execution hardware for long latency type of operations, such as a multiplier, shifts, flag logic, and branch processing. Memory load/store operations are executed by the AGUs 612, 614. For one embodiment, the integer ALUs 616, 618, 620, are described in the context of performing integer operations on 64 bit data operands. In alternative embodiments, the ALUs 616, 618, 620, can be implemented to support a variety of data bits including 16, 32, 128, 256, etc. Similarly, the floating point units 622, 624, can be implemented to support a range of operands having bits of various widths. For one embodiment, the floating point units 622, 624, can operate on 128 bits wide packed data operands in conjunction with SIMD and multimedia instructions.

In one embodiment, the uops schedulers 602, 604, 606, dispatch dependent operations before the parent load has finished executing. As uops are speculatively scheduled and executed in processor 600, the processor 600 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The processor 600 also includes logic to implement store address prediction for memory disambiguation according to embodiments of the disclosure. In one embodiment, the execution block 611 of processor 600 may include a store address predictor (not shown) for implementing store address prediction for memory disambiguation.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions below, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

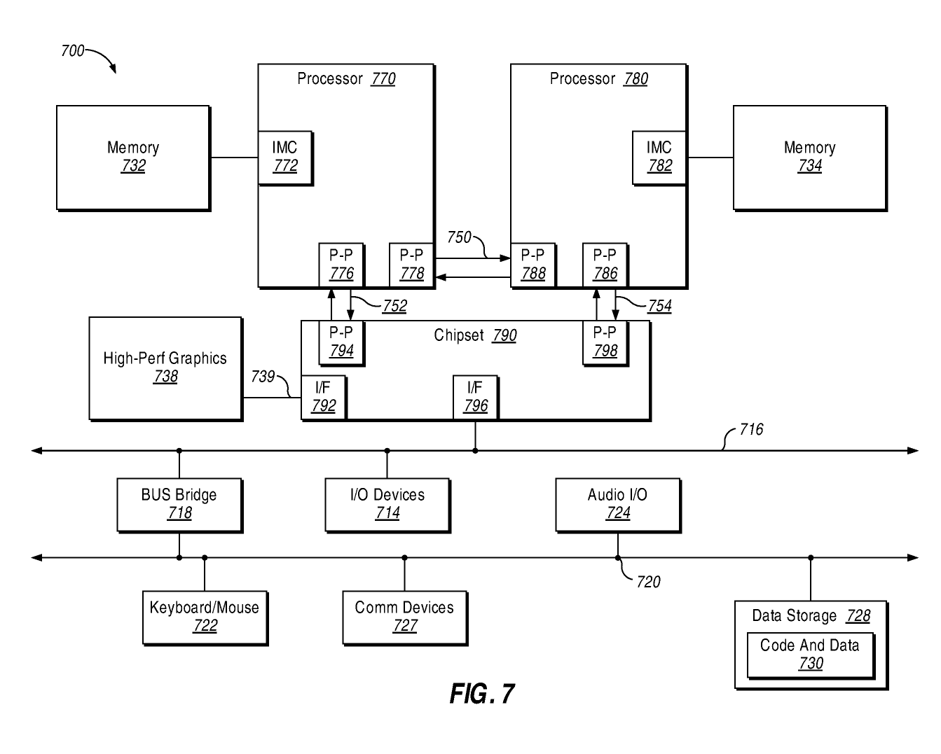

Referring now to FIG. 7, shown is a block diagram illustrating a system 700 in which an embodiment of the disclosure may be used. As shown in FIG. 7, multiprocessor system 700 is a point-to-point interconnect system, and includes a first processor 770 and a second processor 780 coupled via a point-to-point interconnect 750. While shown with only two processors 770, 780, it is to be understood that the scope of embodiments of the disclosure is not so limited. In other embodiments, one or more additional processors may be present in a given processor. In one embodiment, the multiprocessor system 700 may implement hybrid cores as described herein.

Processors 770 and 780 are shown including integrated memory controller units 772 and 782, respectively. Processor 770 also includes as part of its bus controller units point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may also exchange information with a high-performance graphics circuit 738 via a high-performance graphics interface 739.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 may be coupled to first bus 716, along with a bus bridge 718 which couples first bus 716 to a second bus 720. In one embodiment, second bus 720 may be a low pin count (LPC) bus. Various devices may be coupled to second bus 720 including, for example, a keyboard and/or mouse 722, communication devices 727 and a storage unit 728 such as a disk drive or other mass storage device which may include instructions/code and data 730, in one embodiment. Further, an audio I/O 724 may be coupled to second bus 720. Note that other architectures are possible. For example, instead of the point-to-point architecture of FIG. 7, a system may implement a multi-drop bus or other such architecture.

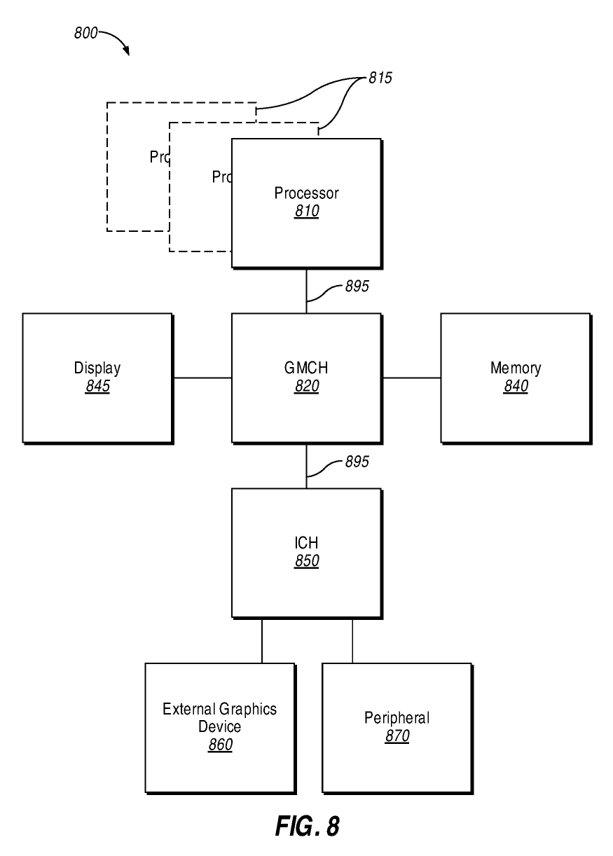

Referring now to FIG. 8, shown is a block diagram of a system 800 in which one embodiment of the disclosure may operate. The system 800 may include one or more processors 810, 815, which are coupled to graphics memory controller hub (GMCH) 820. The optional nature of additional processors 815 is denoted in FIG. 8 with broken lines. In one embodiment, processors 810, 815 implement hybrid cores according to embodiments of the disclosure.

Each processor 810, 815 may be some version of the circuit, integrated circuit, processor, and/or silicon integrated circuit as described above. However, it should be noted that it is unlikely that integrated graphics logic and integrated memory control units would exist in the processors 810, 815. FIG. 8 illustrates that the GMCH 820 may be coupled to a memory 840 that may be, for example, a dynamic random access memory (DRAM). The DRAM may, for at least one embodiment, be associated with a non-volatile cache.

The GMCH 820 may be a chipset, or a portion of a chipset. The GMCH 820 may communicate with the processor(s) 810, 815 and control interaction between the processor(s) 810, 815 and memory 840. The GMCH 820 may also act as an accelerated bus interface between the processor(s) 810, 815 and other elements of the system 800. For at least one embodiment, the GMCH 820 communicates with the processor(s) 810, 815 via a multi-drop bus, such as a frontside bus (FSB) 895.

Furthermore, GMCH 820 is coupled to a display 845 (such as a flat panel or touchscreen display). GMCH 820 may include an integrated graphics accelerator. GMCH 820 is further coupled to an input/output (I/O) controller hub (ICH) 850, which may be used to couple various peripheral devices to system 800. Shown for example in the embodiment of FIG. 8 is an external graphics device 860, which may be a discrete graphics device, coupled to ICH 850, along with another peripheral device 870.

Alternatively, additional or different processors may also be present in the system 800. For example, additional processor(s) 815 may include additional processors(s) that are the same as processor 810, additional processor(s) that are heterogeneous or asymmetric to processor 810, accelerators (such as, e.g., graphics accelerators or digital signal processing (DSP) units), field programmable gate arrays, or any other processor. There can be a variety of differences between the processor(s) 810, 815 in terms of a spectrum of metrics of merit including architectural, micro-architectural, thermal, power consumption characteristics, and the like. These differences may effectively manifest themselves as asymmetry and heterogeneity amongst the processors 810, 815. For at least one embodiment, the various processors 810, 815 may reside in the same die package.

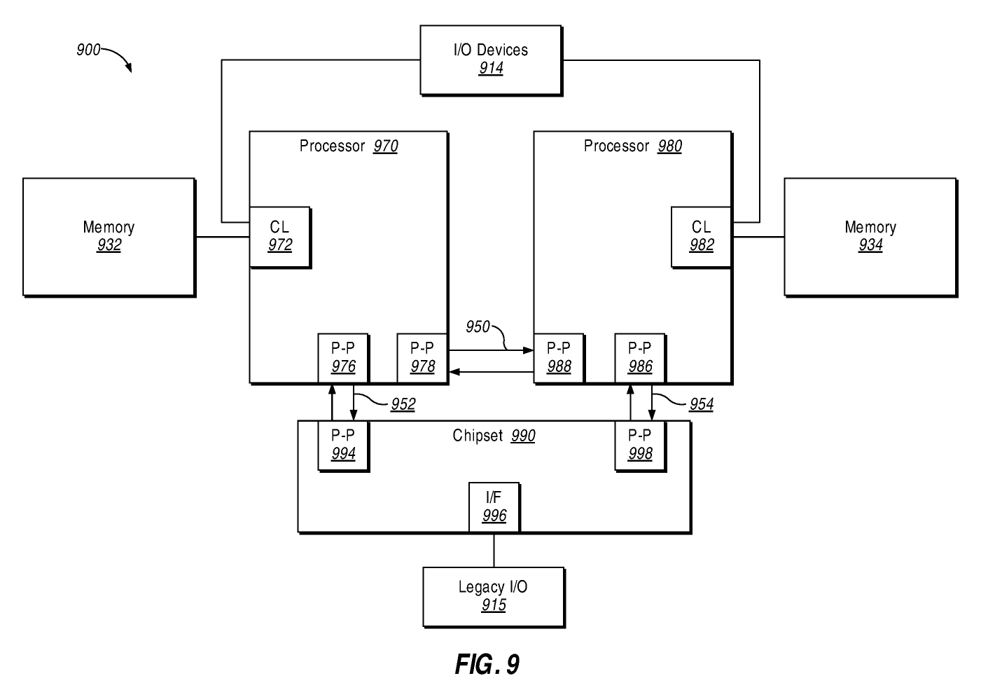

Referring now to FIG. 9, shown is a block diagram of a system 900 in which an embodiment of the disclosure may operate. FIG. 9 illustrates processors 970, 980. In one embodiment, processors 970, 980 may implement hybrid cores as described above. Processors 970, 980 may include integrated memory and I/O control logic (“CL”) 972 and 982, respectively and intercommunicate with each other via point-to-point interconnect 950 between point-to-point (P-P) interfaces 978 and 988 respectively. Processors 970, 980 each communicate with chipset 990 via point-to-point interconnects 952 and 954 through the respective P-P interfaces 976 to 994 and 986 to 998 as shown. For at least one embodiment, the CL 972, 982 may include integrated memory controller units. CLs 972, 982 may include I/O control logic. As depicted, memories 932, 934 coupled to CLs 972, 982 and I/O devices 914 are also coupled to the control logic 972, 982. Legacy I/O devices 915 are coupled to the chipset 990 via interface 996.

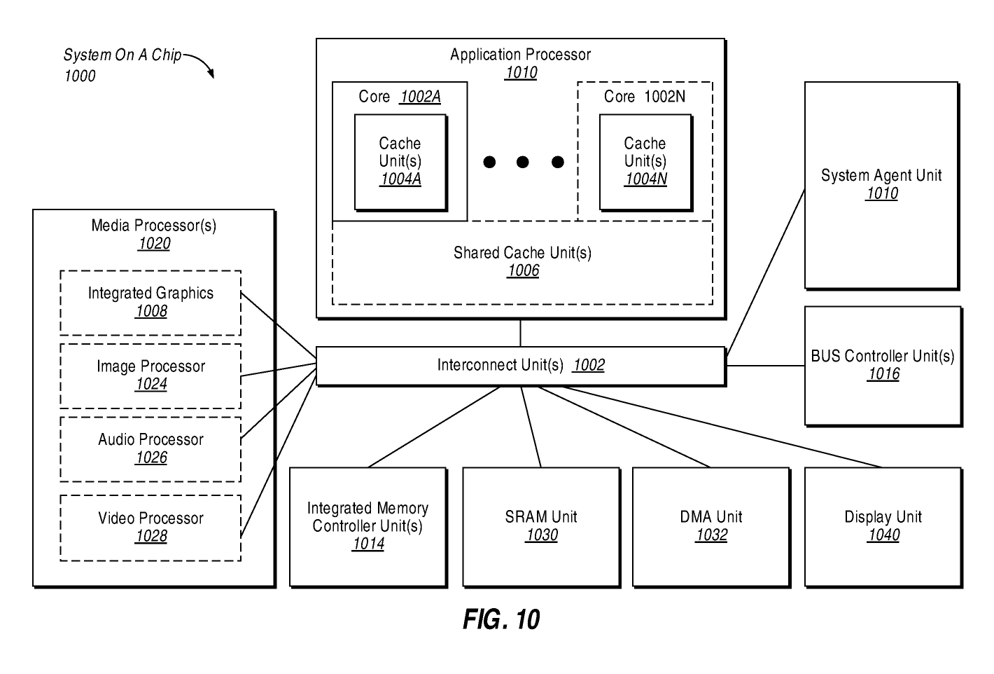

Embodiments may be implemented in many different system types. FIG. 10 is a block diagram of a SoC 1000 in accordance with an embodiment of the present disclosure. Dashed lined boxes are optional features on more advanced SoCs. In FIG. 10, an interconnect unit(s) 1012 is coupled to: an application processor 1020 which includes a set of one or more cores 1002A-N and shared cache unit(s) 1006; a system agent unit 1010; a bus controller unit(s) 1016; an integrated memory controller unit(s) 1014; a set or one or more media processors 1018 which may include integrated graphics logic 1008, an image processor 1024 for providing still and/or video camera functionality, an audio processor 1026 for providing hardware audio acceleration, and a video processor 1028 for providing video encode/decode acceleration; an static random access memory (SRAM) unit 1030; a direct memory access (DMA) unit 1032; and a display unit 1040 for coupling to one or more external displays. In one embodiment, a memory module may be included in the integrated memory controller unit(s) 1014. In another embodiment, the memory module may be included in one or more other components of the SoC 1000 that may be used to access and/or control a memory. The application processor 1020 may include a store address predictor for implementing hybrid cores as described in embodiments herein.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture and/or instruction set. For example, some of the cores 1002A-N may be in order while others are out-of-order. As another example, two or more of the cores 1002A-N may be capable of execution the same instruction set, while others may be capable of executing only a subset of that instruction set or a different instruction set.

The application processor 1020 may be a general-purpose processor, such as a Core™ i3, i5, i7, 2 Duo and Quad, Xeon™, Itanium™, Atom™ or Quark™ processor, which are available from Intel™ Corporation, of Santa Clara, Calif. Alternatively, the application processor 1020 may be from another company, such as ARM Holdings™, Ltd, MIPS™, etc. The application processor 1020 may be a special-purpose processor, such as, for example, a network or communication processor, compression engine, graphics processor, co-processor, embedded processor, or the like. The application processor 1020 may be implemented on one or more chips. The application processor 1020 may be a part of and/or may be implemented on one or more substrates using any of a number of process technologies, such as, for example, BiCMOS, CMOS, or NMOS.

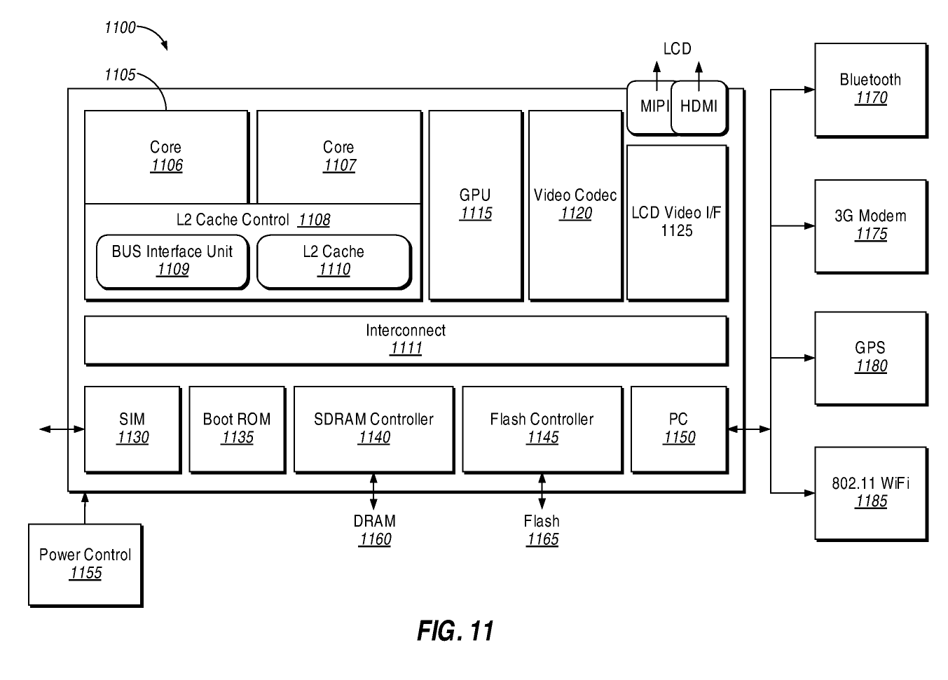

FIG. 11 is a block diagram of an embodiment of a system on-chip (SoC) design in accordance with the present disclosure. As a specific illustrative example, SoC 1100 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 1100 includes 2 cores—1106 and 1107. Cores 1106 and 1107 may conform to an Instruction Set Architecture, such as an Intel® Architecture Core™-based processor, an Advanced Micro Devices, Inc. (AMID) processor, a MIPS-based processor, an ARM-based processor design, or a customer thereof, as well as their licensees or adopters. Cores 1106 and 1107 are coupled to cache control 1108 that is associated with bus interface unit 1109 and L2 cache 1110 to communicate with other parts of system 1100. Interconnect 1110 includes an on-chip interconnect, such as an IOSF, AMBA, or other interconnect discussed above, which potentially implements one or more aspects of the described disclosure. In one embodiment, cores 1106, 1107 may implement hybrid cores as described in embodiments herein.

Interconnect 1110 provides communication channels to the other components, such as a Subscriber Identity Module (SIM) 1130 to interface with a SIM card, a boot ROM 1135 to hold boot code for execution by cores 1106 and 1107 to initialize and boot SoC 1100, a SDRAM controller 1140 to interface with external memory (e.g. DRAM 1160), a flash controller 1145 to interface with non-volatile memory (e.g. Flash 1165), a peripheral control 1150 (e.g. Serial Peripheral Interface) to interface with peripherals, video codecs 1120 and Video interface 1125 to display and receive input (e.g. touch enabled input), GPU 1115 to perform graphics related computations, etc. Any of these interfaces may incorporate aspects of the disclosure described herein. In addition, the system 1100 illustrates peripherals for communication, such as a Bluetooth module 1170, 3G modem 1175, GPS 1180, and Wi-Fi 1185.

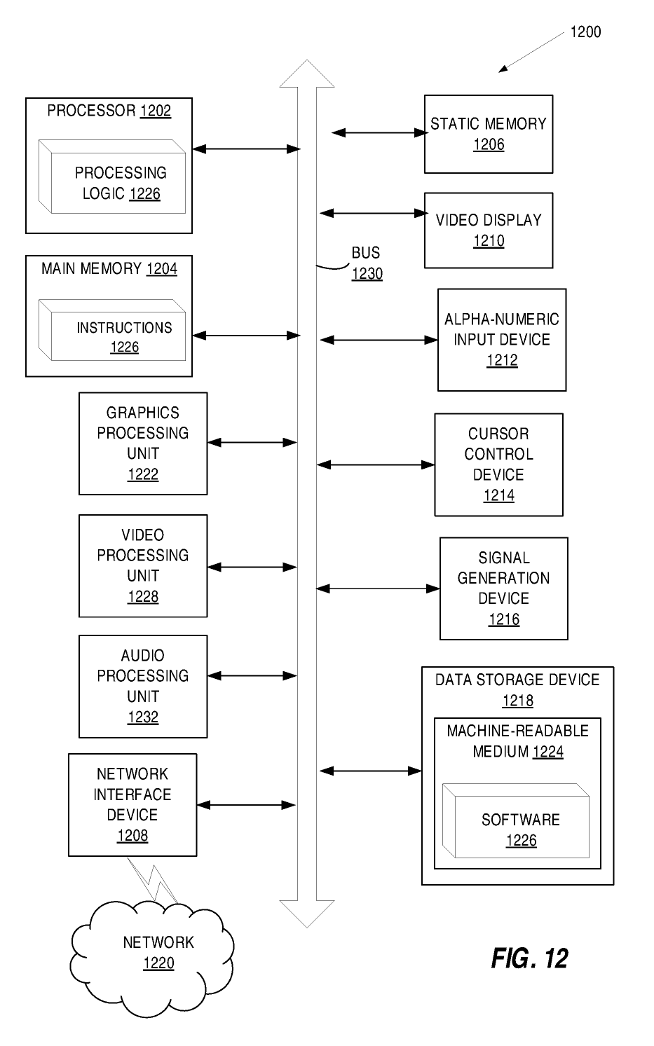

FIG. 12 illustrates a diagrammatic representation of a machine in the example form of a computer system 1200 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1200 includes a processing device 1202, a main memory 1204 (e.g., read-only memory (ROM), flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1218, which communicate with each other via a bus 1230.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. In one embodiment, processing device 1202 may include one or processing cores. The processing device 1202 is configured to execute the processing logic 1226 for performing the operations and steps discussed herein. In one embodiment, processing device 1202 is the same as processor architecture 100 described with respect to FIG. 1 as described herein with embodiments of the disclosure.

The computer system 1200 may further include a network interface device 1208 communicably coupled to a network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1216 (e.g., a speaker). Furthermore, computer system 1200 may include a graphics processing unit 1222, a video processing unit 1228, and an audio processing unit 1232.

The data storage device 1218 may include a machine-accessible storage medium 1224 on which is stored software 1226 implementing any one or more of the methodologies of functions described herein, such as implementing store address prediction for memory disambiguation as described above. The software 1226 may also reside, completely or at least partially, within the main memory 1204 as instructions 1226 and/or within the processing device 1202 as processing logic 1226 during execution thereof by the computer system 1200; the main memory 1204 and the processing device 1202 also constituting machine-accessible storage media.

The machine-readable storage medium 1224 may also be used to store instructions 1226 implementing store address prediction for hybrid cores such as described according to embodiments of the disclosure. While the machine-accessible storage medium 1128 is shown in an example embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present disclosure. The term “machine-accessible storage medium” shall accordingly be taken to include, but not be limited to, solid-state memories, and optical and magnetic media.

The following examples pertain to further embodiments. Example 1 is a processor including a first core including a cache including a cache line, a second core including a second cache, and a cache controller to set a flag stored in a flag section of the cache line of the first cache to one of a processor share (PS) state in response to data stored in the first cache line being shared by the second cache, or to a global share (GS) state in response to the data stored in the first cache line being shared by a third cache of a second processor.

In Example 2, the subject matter of Example 1 can optionally provide that the first core is in a first core cluster and the second core is in a second core cluster.

In Example 3, the subject matter of Example 2 can optionally provide that the cache controller is to set the flag to a cluster share (CS) state responsive to determining that the data stored in the cache line is shared by a fourth cache of a third core, and wherein the first core and the third core are both in the first core cluster of the processor, and wherein the data stored in the cache line is not shared by the second core or by the second processor.

In Example 4, the subject matter of any of Examples 1 to 3 can optionally provide that the cache controller is to set the flag to state, a modified (M) state in response to the data stored in the cache line being modified from a copy of the data stored in a memory, to an exclusive (E) state responsive to determining that the data stored in the cache line is not shared by another cache, or an invalid state (I) in response to the data stored in the cache line being invalid.

In Example 5, the subject matter of any of Examples 1 to 3 can optionally provide that the cache line further comprises a data section to store the data and a tag section to store an address of a memory at which the corresponding copy of the data is stored.

In Example 6, the subject matter of Example 4 can optionally provide that the cache controller is to in response to detecting a cache hit from the third core with respect to the data stored in the cache line of the first cache, set the flag of the cache line from the exclusive state to the cluster share state, in response to detecting a cache hit from a fourth core in a second core cluster of the processor, set the flag of the cache line from one of the exclusive state or the cluster share state to the processor share state, and in response to detecting a cache hit from the second processor, set the flag of the cache line from one of the exclusive state, the cluster share state or the processor share state to the global share state.

In Example 7, the subject matter of Example 4 can optionally provide that the cache controller is to, in response to detecting a write hit on the data stored in the cache line, determine which state the flag is.

In Example 8, the subject matter of Example 7 can optionally provide that the cache controller is further to, in response to determining that the flag indicates the cluster share state, transmit a cache invalidation request to one or more caches of the first core cluster.

In Example 9, the subject matter of Example 8 can optionally provide that the cache invalidation request is transmitted only to one or more caches within the first core cluster, and wherein the cache controller transmits the cache invalidation request on an inter-core interconnect of the processor.

In Example 10, the subject matter of Example 9 can optionally provide that the cache controller is to, in response to determining that is the flag indicates the processor share state, transmit a cache invalidation request to one or more caches of the processor.

In Example 11, the subject matter of Example 10 can optionally provide that the cache invalidation request is transmitted only to caches within the processor, and wherein the cache controller transmits the cache invalidation request on an inter-cluster interconnect of the processor.

In Example 12, the subject matter of Example 7 can optionally provide that the cache controller is to, in response to determining that the flag indicates the global share state, transmit a cache invalidation request to one or more caches in the processor and the second processor.

In Example 13, the subject matter of Example 12 can optionally provide that the cache controller transmits the cache invalidation request on an inter-processor interconnect coupled between the first processor and the second processor.

Example 14 is a system-on-a-chip (SoC) including a memory and a first processor. The first processor includes a first core cluster including a first core including a first cache and a second core including a second cache, and a cache controller to set a flag stored in a flag section of a cache line of the first cache to one of a cluster share (CS) state in response to data stored in the cache line being shared by the second cache or a global share (GS) state in response to the data stored in the cache line being shared by a third cache of a second processor of the SoC.

In Example 15, the subject matter of Example 14 can optionally provide that the cache controller is to set the flag of the cache line to a processor share (PS) state in response to the data stored in the cache line being shared by a fourth cache in a second core cluster of the first processor, and wherein the data is not shared by the second processor.

In Example 16, the subject matter of any of Examples 14 and 15 can optionally provide that the cache line further comprises a data section to store the data and a tag section to store an address of the memory at which a copy of the data is stored.

Example 17 includes a method including receiving, by a cache controller, a request to read a data item stored in a cache line of a first cache of a first core residing in a first core cluster of a first processor, in response to determining that a requester of the request is associated with the first core cluster and a flag stored in a flag section is an exclusive state to the first cache, setting the flag stored in the flag section of the cache line to cluster share, and in response to determining that the requester is associated with a second core cluster of the first processor and the state stored in the flag section is one of the exclusive state or the cluster share state, setting the flag stored in the flag section of the cache line to a processor share state.

In Example 18, the subject matter of Example 17 can further include, in response to determining that the requester is in a second processor, setting the flag stored in the flag section of the cache line to a global share state.

In Example 19, the subject matter of any of Examples 17 and 18 can further include transmitting the data from the first cache to the requester.

In Example 20, the subject matter of any of Examples 17 and 18 can further include receiving a request to write a data item to the cache line, determining the flag stored in the flag section of the cache line, in response to determining that the flag is the cluster share state, transmitting a cache invalidation request to one or more caches of the first core cluster and refraining from transmitting the cache invalidation request outside the first core cluster, and in response to determining that the flag is the processor share state, transmitting the cache invalidation request to one or more caches of the first processor, but refraining from transmitting the cache invalidation request to caches outside the first processor.

Example 21 includes an apparatus comprising: means for performing the method of any one of Examples 17 to 18.

Example 22 includes a machine-readable non-transitory medium having stored thereon program codes that, when executed, perform operations. The operations include receiving, by a cache controller, a request to read a data item stored in a cache line of a first cache of a first core residing in a first core cluster of a first processor, in response to determining that a requester of the request is associated with the first core cluster and a flag stored in a flag section is an exclusive state to the first cache, setting the flag stored in the flag section of the cache line to cluster share, and in response to determining that the requester is associated with a second core cluster of the first processor and the state stored in the flag section is one of the exclusive state or the cluster share state, setting the flag stored in the flag section of the cache line to a processor share state.

In Example 23, the subject matter of Example 22 can optionally provide that the operations include, in response to determining that the requester is in a second processor, setting the flag stored in the flag section of the cache line to a global share state.

In Example 24, the subject matter of any of Examples 22 and 23 can optionally provide that the operations include transmitting the data from the first cache to the requester.

In Example 24, the subject matter of any of Examples 22 and 23 can optionally provide that the operations include receiving a request to write a data item to the cache line, determining the flag stored in the flag section of the cache line, in response to determining that the flag is the cluster share state, transmitting a cache invalidation request to one or more caches of the first core cluster and refraining from transmitting the cache invalidation request outside the first core cluster, and in response to determining that the flag is the processor share state, transmitting the cache invalidation request to one or more caches of the first processor, but refraining from transmitting the cache invalidation request to caches outside the first processor.

While the disclosure has been described with respect to a limited number of embodiments, those skilled in the art will appreciate numerous modifications and variations there from. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. A processor, comprising:
a first core comprising a first cache, the first cache comprising a cache line;
a second core comprising a second cache; and
a cache controller to set a flag stored in a flag section of the cache line of the first cache to one of a processor share (PS) state in response to data stored in the first cache line being shared by the second cache, or to a global share (GS) state in response to the data stored in the first cache line being shared by a third cache of a second processor.

2. The processor of claim 1, wherein the first core is in a first core cluster and the second core is in a second core cluster.

3. The processor of claim 2, wherein the cache controller is to set the flag to a cluster share (CS) state responsive to determining that the data stored in the cache line is shared by a fourth cache of a third core, and wherein the first core and the third core are both in the first core cluster of the processor, and wherein the data stored in the cache line is not shared by the second core or by the second processor.

4. The processor of claim 3, wherein the cache controller is to set the flag to state, a modified (M) state in response to the data stored in the cache line being modified from a copy of the data stored in a memory, to an exclusive (E) state responsive to determining that the data stored in the cache line is not shared by another cache, or an invalid state (I) in response to the data stored in the cache line being invalid.

5. The processor of claim 3, wherein the cache line further comprises a data section to store the data and a tag section to store an address of a memory at which the corresponding copy of the data is stored.

6. The processor of claim 4, wherein the cache controller is to:
in response to detecting a cache hit from the third core with respect to the data stored in the cache line of the first cache, set the flag of the cache line from the exclusive state to the cluster share state;
in response to detecting a cache hit from a fourth core in a second core cluster of the processor, set the flag of the cache line from one of the exclusive state or the cluster share state to the processor share state; and
in response to detecting a cache hit from the second processor, set the flag of the cache line from one of the exclusive state, the cluster share state or the processor share state to the global share state.

7. The processor of claim 4, wherein the cache controller is further to:
in response to detecting a write hit on the data stored in the cache line, determine which state the flag is.

8. The processor of claim 7, wherein the cache controller is further to:
in response to determining that the flag indicates the cluster share state, transmit a cache invalidation request to one or more caches of the first core cluster.

9. The processor of claim 8, wherein the cache invalidation request is transmitted only to one or more caches within the first core cluster, and wherein the cache controller transmits the cache invalidation request on an inter-core interconnect of the processor.

10. The processor of claim 7, wherein the cache controller is to:
in response to determining that is the flag indicates the processor share state, transmit a cache invalidation request to one or more caches of the processor.

11. The processor of claim 10, wherein the cache invalidation request is transmitted only to caches within the processor, and wherein the cache controller transmits the cache invalidation request on an inter-cluster interconnect of the processor.

12. The processor of claim 7, wherein the cache controller is to:
in response to determining that the flag indicates the global share state, transmit a cache invalidation request to one or more caches in the processor and the second processor.

13. The processor of claim 12, wherein the cache controller transmits the cache invalidation request on an inter-processor interconnect coupled between the first processor and the second processor.

14. A system-on-a-chip (SoC) comprising:
a memory; and
a first processor comprising:
a first core cluster comprising a first core comprising a first cache and a second core comprising a second cache; and
a cache controller to set a flag stored in a flag section of a cache line of the first cache to one of a cluster share (CS) state in response to data stored in the cache line being shared by the second cache or a global share (GS) state in response to the data stored in the cache line being shared by a third cache of a second processor of the SoC.

15. The SoC of claim 14, wherein the cache controller is to set the flag of the cache line to a processor share (PS) state in response to the data stored in the cache line being shared by a fourth cache in a second core cluster of the first processor, and wherein the data is not shared by the second processor.

16. The SoC of claim 14, wherein the cache line further comprises a data section to store the data and a tag section to store an address of the memory at which a copy of the data is stored.

17. A method, comprising:
receiving, by a cache controller, a request to read a data item stored in a cache line of a first cache of a first core residing in a first core cluster of a first processor;
in response to determining that a requester of the request is associated with the first core cluster and a flag stored in a flag section is an exclusive state to the first cache, setting the flag stored in the flag section of the cache line to cluster share; and
in response to determining that the requester is associated with a second core cluster of the first processor and the state stored in the flag section is one of the exclusive state or the cluster share state, setting the flag stored in the flag section of the cache line to a processor share state.

18. The method of claim 17, further comprising:
in response to determining that the requester is in a second processor, setting the flag stored in the flag section of the cache line to a global share state.

19. The method of claim 17, further comprising transmitting the data from the first cache to the requester.

20. The method of claim 17, the method further comprising:
receiving a request to write a data item to the cache line;
determining the flag stored in the flag section of the cache line;
in response to determining that the flag is the cluster share state, transmitting a cache invalidation request to one or more caches of the first core cluster and refraining from transmitting the cache invalidation request outside the first core cluster; and
in response to determining that the flag is the processor share state, transmitting the cache invalidation request to one or more caches of the first processor, but refraining from transmitting the cache invalidation request to caches outside the first processor.

21. (canceled)
